(19) United States
(12) Patent Application Publication
(10) Pub. No.: US 2010/0040057 A1
(43) Pub. Date: Feb. 18, 2010

(54) COMMUNICATION METHOD

(75) Inventor: Cheng-Hung KO, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/191,694

(22) Filed: Aug. 14, 2008

(51) Int. Cl. H04L 12/56

(52) U.S. Cl. 370/392

(57) ABSTRACT

A communication method for establishing a signal path between a communication apparatus in a local network and a Voice over IP server is provided. The communication method comprises sending a first Internet Protocol (IP) data packet containing private address information to a network server with a public address, the communication apparatus receiving a second IP data packet containing a VIA header, the communication apparatus determining the presence of source address information of the first IP data packet in the VIA header, and the communication apparatus failing the registration when no source address information is found.

### BACKGROUND OF THE INVENTION

1. Field of the Invention

The invention relates in general to voice over IP (VoIP), and in particular, to a communication method and a communication system for VoIP.

2. Description of the Related Art

Voice over Internet Protocol (VoIP) comprises a set of protocols optimized for the transmission of voice through the Internet or other packet switched networks. Voice over IP can be implemented by an SIP (Session Initiation Protocol) developed by the IETF (Internet Engineering Task Force), an application-level control protocol which allows the establishment, alteration and interruption of multimedia connections and voice over IP connections.

The Session Initiation Protocol (SIP) is an application-layer control (signaling) protocol for creating, modifying, and terminating sessions with one or more participants, creating multiparty or multicast sessions that include voice over IP, multimedia distribution, and multimedia conferences.

Network Address Translation (NAT, also known as Network Masquerading, Native Address Translation or IP Masquerading) servers deal with the problem of IP address shortages and mitigate the difficulty of reserving IP addresses. A NAT server is used for network address translation so that a limited number of public IP addresses of a private network can be shared by all devices in the private network. The NAT server converts the private IP addresses of each device to the public IP addresses for Internet access to enable multiple network devices on the private network to access the Internet using limited public IP addresses. In a typical NAT configuration, NAT servers not only translate IP addresses but also port numbers (Port Address Translation, PAT). NAT servers may comprise more than 1 internal and external port, and outgoing packets from an internal port are routed to one of the available external ports for transmission.

NAT servers are classified into 4 types depending on connection behaviors, namely, full cone NATs, restricted cone NATs, port restricted cone NATs, and symmetric NATs. Full cone NATs, restricted cone NATs, and port restricted cone NATs are also referred to as non-symetric NATs. Full cone NATs, also known as one-to-one NATs, map all outgoing packets to a specific external port number and public IP address and redirect all incoming packets to a specific internal port number and private IP address. All external servers can send data packets to the external port number and public IP address of the full cone NATs. Restricted cone NATs also route all outgoing packets to a specific external port number and public IP address, and only accept packets from the external servers that previously received the packets. A Port restricted cone NAT only accepts data packets from a particular port of an external server that has received outgoing packets from a particular external port number of the port restricted cone NAT. For a symmetric NAT, all requests from the same internal IP address and port, to a specific destination IP address and port, are mapped to the same external IP address and port. If the same host sends a packet with the same source address and port to a different destination, a different address mapping is used. Furthermore, only the external host that receives a packet can send a UDP packet back to the internal host.

NATs can cause problems in cases where multiple devices such as SIP phones are located behind a NAT. Thus, a need exists for a communication method which establishes a signal path between a communication apparatus in a local network and an SIP server to handle the problem of locating the communication apparatus behind a NAT server, without the use of additional servers and complying with VoIP protocol requirements.

### BRIEF SUMMARY OF THE INVENTION

A detailed description is given in the following embodiments with reference to the accompanying drawings.

A communication method for establish a signal path between a communication apparatus in a local network and a Voice over IP server is provided, comprising sending a first Internet Protocol (IP) data packet containing private address information to a network server with a public address, the communication apparatus receiving a second IP data packet containing a VIA header, the communication apparatus determining the presence of source address information of the first IP data packet in the VIA header, and the communication apparatus failing the registration when no source address information is found.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary voice over IP (VoIP) communication system according to an embodiment of the invention.

FIG. 2 is a timing chart illustrating a conventional communication method for VoIP.

FIG. 3 is a timing chart showing another conventional communication method for VoIP.

FIG. 4 is a timing chart showing a VoIP communication method according to an embodiment of the invention.

FIG. 5 is a flowchart of an exemplary communication method according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Messages or data packet being transmitted in networks typically contain a header and a payload. The address information may be included in the payload portion of the data packet in some applications, such as the registration portion. When data packets are transmitted through a network, specific source IP address and/or port number information are changed in the header. Since NAT translates the source IP addresses, when data packets pass therethrough, the applications that use IP addresses carried in the payload portion fail in the presence of the NAT. Thus, VoIP services cannot be provided to a NAT-based private network. The present invention provides a solution to support VoIP services compatible with the NAT without the requirement of an external STUN server, such that the data packet may be routed properly to the desired destination from a public network source to a local destination node in a private network and vice versa.

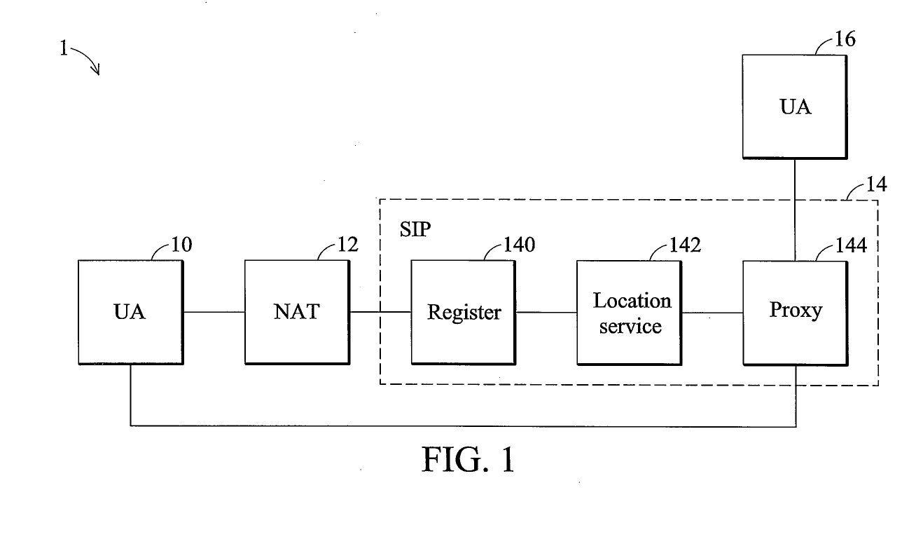

In an exemplary embodiment of the present invention, a Session Initiation Protocol (SIP) is used for signaling control to provide VoIP services. FIG. 1 is a block diagram of an exemplary voice over IP (VoIP) communication system using a SIP protocol according to the invention, comprising a communication apparatus 10, an NAT server 12, an SIP server 14, and a remote communication apparatus 16. The communication apparatus 10 is coupled to the NAT server 12, the SIP server 14, and then to the remote communication apparatus 16. For illustration purposes, FIG. 1 shows two user agents (UA) 10 and 16, and each have a private IP address. UA 10 has a globally unique registered IP address provided by the NAT that is recognized by the public network, including the remote communication apparatus 16.

The VoIP system 1 employs the SIP protocol to transmit a request, a response, or a message, and activities of a session established between a local communication apparatus and a remote apparatus are described as follows. Prior to establishing the session, the communication apparatus in the private network needs to register an address in a SIP server so that the remote apparatus can locate and exchange multimedia data with the communication apparatus. SIP messages are carried in the payload of the UDP/IP packets with the header containing the source and destination addresses and port numbers.

The SIP server 14 comprises a register unit 140, a location service unit 142, and a proxy server 144 coupled in series. The communication apparatus sends a REGISTER request including its public address to the register unit 140 for registration, whereafter the register unit 140 then stores the public address in the location service unit 142. An example of a call being placed from the remote communication apparatus 16 to the communication apparatus 10 is as follows. First, a call signaling path is set up by the remote communication apparatus 16 by delivering an INVITE request to the proxy server 144, and the proxy server 144 firstly queries the location of the communication apparatus 10 by sending a query request to the location service unit 142. Next, the proxy server 144 receives the public address of the communication apparatus 10 so that the proxy server 144 can further and accordingly, forward the INVITE request for media session establishment. If the public address is correct, the communication apparatus 10 receives the INVITE request and responds with a SIP 180 Ringing response while awaiting acceptance of the INVITE request. Upon acceptance of the INVITE request, the communication apparatus 10 transmits a SIP 200 OK response to the remote communication apparatus 16, and in response to the SIP 200 OK response, the remote communication apparatus 16 sends an ACK response to the communication apparatus 10 and starts exchanging data packets.

The communication apparatus 10 comprises a user agent performing registration in an SIP server 14 and establishing the media session with the remote communication apparatus 16 according to the session initiation protocol. The communication apparatus 10 exchanges signals with the SIP server 14 though a NAT server 12, i.e., the source address of the outgoing packets is converted to a public address and the destination address of the incoming packets is converted back to a private address when data packets pass through the NAT server 12. The NAT server 12 translates the private to public IP addresses, converts the TCP/UDP port numbers of the IP packets as they pass through, and retains an NAT table containing the mapped private and public IP addresses and port numbers. There is a 1:1 correspondence between the publicly exposed IP addresses and privately held IP addresses, and the external and the internal port numbers in the NAT table. Upon reciept of the incoming packets, the NAT device 12 redirects the incoming packets from a specific external IP address and external port number to an internal IP address and the internal port number according to the NAT table.

Register unit 140 receives a REGISTER request from the communication apparatus 10, extracts the public address information in the REGISTER request for storage in a location service unit 142, and sends a success response (SIP 200 OK) to the communication apparatus 10. During the media session, in addition to the signal path being regulated by the SIP, multimedia data are exchanged between the communication apparatus 10 and the remote communication apparatus 16.

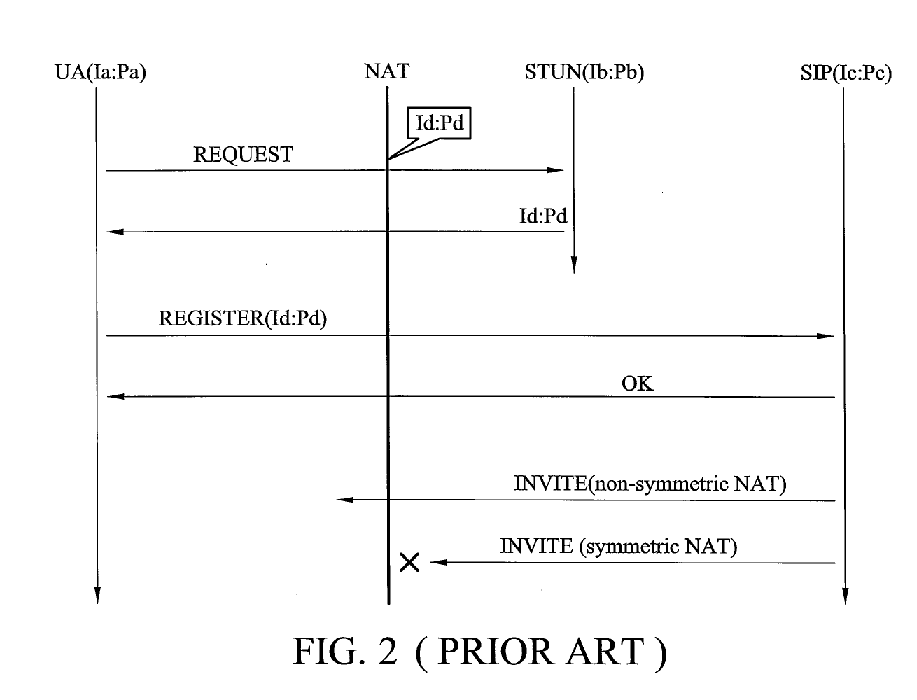

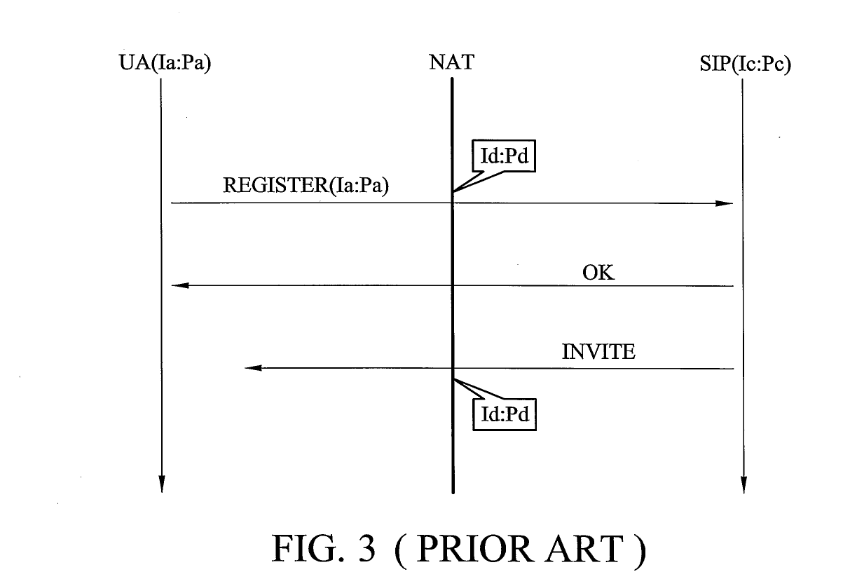

Conventionally, the NAT server 12 translates the address of the data packets originated from the communication apparatus 10 to a public address, but the private address of the data packets is recorded in a location service unit 142, causing the problem where the proxy server 144 forwards the INVITE request to the wrong address (the private address) instead of the globally recognizable public address. Some solutions have been proposed to deal with the problem, by employing an additional STUN server or specially designed SIP server, as illustrated in FIGS. 2 and 3.

FIG. 2 is a timing chart illustrating a conventional communication method for a VoIP, incorporating a VoIP system and a STUN server to determine the public address of data packets.

Simple Traversal of UDP through NATs (STUN), is a network protocol allowing a client behind a NAT to find out its public address and the global port associated by the NAT with a particular local port. This information is used to set up a UDP (User Datagram Protocol) communication between two hosts that are both behind NAT routers. The protocol is defined in an RFC 3489.

In the exemplary embodiment in FIG. 2, a user agent sends a request to a STUN server to query for the global IP address Id and port number Pd, and receves a response with the queried information from the STUN server, thereby obtaining the public IP address Id and port number Pd necessary for address registration. Instead of the private address Ia and the internal port number Pa, the user agent then sends a REGISTER request containing the public address Id and the port number Pd to the SIP server. The user agent then receives an SIP 200 OK response upon successful registration for the public address Id and port number Pd. Thus, when the remote communication apparatus 16 desires to make a VoIP call by issuing an INVITE request to the proxy server 144, the proxy server 144 can query and retrieve the correct public address (Id:Pd) for the recipient, and relay the INVITE request to the communication apparatus 10 through a non-symmetric NAT server 12. When the NAT server 12 is a symmetric NAT, the data packet cannot pass through NAT server 12 since destination address Id and the port number Pd can only be transferred to the private address and port number if the source address and port number are the address and port number of the STUN

Hence, the STUN server solution suffers problems such as, increasing the cost for the VoIP system, increasing the complexity of the system configuration, and operational inability for a symmetric NAT.

FIG. 3 is a timing chart showing another conventional communication method for a VoIP, incorporating an SIP server capable of sending data packets back to where the data packets have been received from. In the illustrated embodiment, the communication apparatus sends a REGISTER request containing its private IP address Ia and the internal port number Pa to the SIP server through the NAT. The source IP address and the source port number of the REGISTER request are translated from the private IP address Ia and the internal port number Pa to a public IP address Id and an external port number Pd as the data packet passes through the NAT. Upon registration, the SIP server records the source IP address and the source port number, rather than the (Ia:Pa) carried in the REGISTER request, and replies a SIP 200 OK response according to the source address and the source port number where the REGISTER request originated from, i.e., the SIP 200 OK response is sent to the public IP address Id and the external port number Pd at the NAT server. The NAT server then translates the public IP address Id and the external port number Pd back to the private IP address and the internal port number according to the NAT table and directs the SIP 200 OK response to the communication apparatus. When a call is made to the communication apparatus, the SIP server delivers an INVITE request to the public IP address Id and the external port number Pd at the NAT, where the data packets are redirected to the appropriate communication apparatus according the NAT table.

Although the adapted SIP server provides a solution for establishing a media session between the remote apparatus and the communication apparatus behind the NAT, it violates RFC 3261 protocol regulation and consequently tends to have problems when it interacts with the user agents or servers fully compliant to the RFC 3261. For example, for this adapted SIP server, it is impossible to register the contact address for the third party user agent.

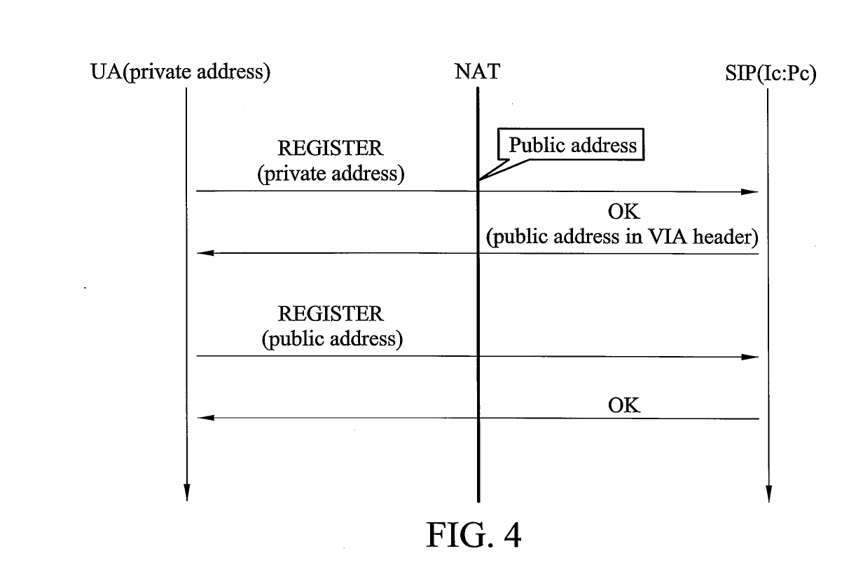

An exemplary communication method for establish a signal path between the communication apparatus in a local network and the SIP (Voice over IP) server according to the invention is disclosed in FIG. 4. FIG. 4 is a timing chart showing a VoIP communication method according to an embodiment of the invention, incorporating the communication system in FIG. 1.

In the illustrated embodiment, the communication apparatus 10 sends a REGISTER request containing the private address information through the NAT server 12 to the SIP server 14, with the source address and the internal port number being translated to the public address and the external port number at the NAT server 12. The SIP server 14 in turn responds an SIP 200 OK response which includes a VIA header with a received parameter and a rport parameter to the NAT server 12. The “received” parameter carries the source IP information and the “rport” parameter carries the source port number information of where the incoming request data packet came from. In the embodiment, the public IP address is conveyed in the “received” parameter and the external port number is conveyed in the “rport” parameter in the VIA header of the SIP 200 OK response. Next, the communication apparatus 10 receives the SIP 200 OK response from the SIP server 14, determines the presence of the “received” parameter and “rport” parameter, and determines failure of the registration operation if the “received” parameter and “rport” parameter are absent in the VIA header. If both parameters are available, the communication apparatus 10 then performs a comparison for the private IP address and the “received” parameter, and the internal port number and the “rport” parameter. If both comparisons match, the communication apparatus 10 determines that the registration is approved. If one or both comparison are mismatched, the communication apparatus 10 then issues another REGISTER request containing the source IP address and the source port number in the Contact header to the SIP server 14, and removes the previous registration by setting the private IP address and the internal port number as being expired. The expiration of the registration can be set together in the second REGISTER request data packet. Following, the communication apparatus 10 further receives a second SIP 200 OK response from the SIP server 14 upon approval of the second registration. In the embodiment, the “received” parameter contains the source IP address and the “rport” parameter contains the source port number of the REGISTER request, thus they are different from the private address and the internal port number. Therefore, the communication apparatus 10 sends a second REGISTER request containing two sets of Contact headers, wherein one sets the expiration of the private address information (Ia:Pa) and the other sets the registration of the public address information (Id:Pd). The communication apparatus 10 then receives an SIP 200 OK response from the SIP server 14 upon the completion of the registration for the public recognizable address information (Id:Pd).

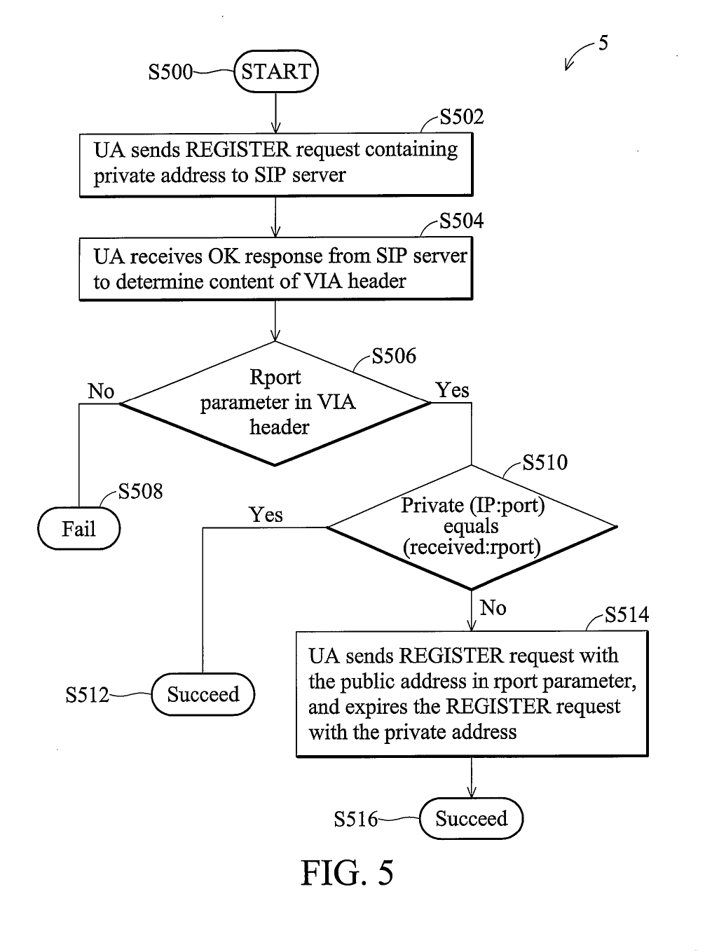

FIG. 5 is a flowchart of an exemplary communication method according to the invention, incorporating the communication system in FIG. 1.

The communication method 5 starts at step S500. In step S502, the communication device 10 sends a first Internet Protocol (IP) data packet containing private address information from a network server with a public address. The IP data packets carries Voice over Internet Protocol (VoIP) messages, which may be implemented by a Session Initiation Protocol (SIP). In the embodiment of the SIP protocol, and the first IP data packet is a REGISTER request. The private address information includes the private IP address Ia and the internal port number Pa of the communication apparatus 10. The public address includes the public IP address Id and the internal port number Pd translated by the network server. The network server is a NAT server 12, and may be a symmetric server or a non-symmetric server.

Next in step S504, the communication apparatus 10 receives a second IP data packet containing a VIA header that may comprise “received” and “rport” parameters. In the example of an SIP protocol, the second IP data packet is an SIP 200 OK response, and the “received” and “rport” parameters hold the source IP address and the source port number of the REGISTER request, i.e., the REGISTER request corresponding to the public IP address Id and the external port number Pd. The VIA header is compliant with the RFC 3581 protocol.

In the next step, the communication apparatus 10 determines the presence of the source address information of the first IP data packet in the VIA header (S506). Specifically, the communication apparatus 10 determines the presence of the “received” and the “rport” parameters in the VIA header. The IP address of the source address is in a received parameter of the VIA header, and the port number of the source address is in “rport” parameter of the VIA header. The public address and the source address information are identical, or, the source IP address is address Id and the source port number is the port number Pd.

In step S508, the communication apparatus 10 determines failure of the registration when the source address information is absent in the VIA header.

Then in step S510, the communication apparatus 10 compares the private address information and the source address information.

In step S512, the communication apparatus 10 approves the registration when the private address information matches the source address information.

In step S514, the communication apparatus 10 sends a third IP data packet containing the source address to the SIP server and removes the registration of the private address when the private address information does not match the source address information. In the SIP protocol embodiment, the third IP data packet is another REGISTER request data packet.

Finally in step S516, the communication apparatus 10 receives a fourth IP data packet indicating approval of the registration with the source address information. In the SIP protocol embodiment, the fourth IP data packet is another SIP 200 OK response data packet corresponding to the second REGISTER request.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication method for establishing a signal path between a communication apparatus, in a local network behind a NAT server, and a Voice over IP server, comprising:
sending a first Internet Protocol (IP) data packet containing private address information to a network server with a public address;
the communication apparatus receiving a second IP data packet containing a VIA header;
the communication apparatus determining the presence of source address information of the first IP data packet in the VIA header; and
the communication apparatus failing the registration when no source address information is found.

2. The communication method of claim 1, further comprising:
the communication apparatus comparing the private address information and the source address information; and
the communication apparatus approving the registration when the private address information matches the source address information.

3. The communication method of claim 2, further comprising the communication apparatus sending a third IP data packet containing the source address to the SIP server and removing the registration of the private address when the private address information does not match the source address information.

4. The communication method of claim 1, wherein the private and the source addresses information comprise an IP address and a port number.

5. The communication method of claim 4, wherein the IP address of the source address is in a received parameter of the VIA header, and the port number of the source address is in a rport parameter of the VIA header.

6. The communication method of claim 1, wherein the public address and the source address information are identical.

7. The communication method of claim 1, wherein the VIA header is compliant with an RFC 3581 protocol.

8. The communication method of claim 1, wherein the IP data packets carries Voice over Internet Protocol (VoIP) messages.

9. The communication method of claim 1, wherein the Voice over Internet Protocol is a Session Initiation Protocol (SIP).

10. The communication method of claim 1, wherein the Voice over IP server is a Session Initiation Protocol (SIP) server.

11. The communication method of claim 1, wherein the NAT server is a symmetric server or a non-symmetric server.
